(19) United States
(12) Patent Application Publication
(10) Pub. No.: US 2014/0052646 A1
(43) Pub. Date: Feb. 20, 2014

(54) Closed-Loop Recycling Process

(71) Applicant: Sona ROSS, Miami, FL (US)

(72) Inventor: Sona ROSS, Miami, FL (US)

(21) Appl. No.: 13/586,305

(22) Filed: Aug. 15, 2012

(51) Int. Cl. G06Q 10/00

(52) U.S. Cl. 705/308

(57) ABSTRACT

A closed-loop recycling process provides a way to recycle an entity's waste so that the waste is collected and processed to produce an article, which is then entered back into the entity's system, thereby “closing” the loop. A process for recycling waste can include collecting waste from an entity, inventorying information regarding the waste, analyzing the waste in order to determine how to recycle the waste, processing the analyzed waste to recycle the waste and produce an article, providing the article to the entity, tracking the waste during the process, and providing the entity with a certification that the entity's waste was used to produce the article.

### BACKGROUND OF THE INVENTION

1. Field of the Invention

The present invention relates to a waste recycling process. More particularly, the present invention relates to a closed-loop recycling process wherein an entity's waste is collected and recycled to produce an article, which is then provided to the entity along with a certification that the entity's waste was used to produce the article.

2. Background Art

There is a great emphasis in society to recycle waste in order to preserve natural resources and reduce our carbon footprint, as well as to save money by minimizing the need to produce new raw materials. As a result, companies are under a great social and economic pressure to have “environmentally friendly” and “green” products and programs. In fact, there are many advocates calling for companies to implement, or at least strive toward, a zero waste initiative, whereby all of a company's waste is recycled. It is envisioned that regulations may be put in place requiring companies to account for their waste and to provide certification that their waste is being recycled.

Sources of waste for a company can include pre-consumer waste (for example, manufacturing or production waste) or post-consumer waste (for example, empty bottles or packaging of a product a company sells). It can be difficult for a company to account for what happens to its waste and to be able to certify that it has been recycled, especially post-consumer waste. Accordingly, there is a need for a waste recycling process that can help companies recycle their waste and provide certification as to whether, and how, their waste has been recycled.

### BRIEF SUMMARY OF THE INVENTION

A closed-loop recycling process provides a way to recycle an entity's waste so that the waste is collected and processed to produce an article, which is then entered back into the entity's system, thereby “closing” the loop. In some embodiments, a process for recycling waste can include collecting waste from an entity, inventorying information regarding the waste, analyzing the waste in order to determine how to recycle the waste, processing the analyzed waste to recycle the waste and produce an article, providing the article to the entity, tracking the waste during the process, and providing the entity with a certification that the entity's waste was used to produce the article.

In some embodiments, a process for recycling waste can include collecting waste from a plurality of entities, wherein the waste from each of the plurality of entities is segregated in order to prevent mixing of waste from different entities. The process can also include analyzing the waste of each of the plurality of entities in order to determine how to recycle the waste, processing the analyzed waste of each of the plurality of entities to recycle the waste and produce an article, and providing each of the plurality of entities the article made from its waste, wherein the article does not contain waste from a remainder of the plurality of entities.

### BRIEF DESCRIPTION OF THE DRAWINGS

The accompanying drawings, which are incorporated herein and form a part of the specification, illustrate the present invention by way of example, and not by way of limitation. The drawings together with the description, further serve to explain the principles of the invention and to enable a person skilled in the pertinent art to make and use the invention.

FIG. 1 is a flow chart of an exemplary process for recycling waste.

FIG. 2 is a schematic view illustrating how an aluminum can be recycled and processed to produce a key chain.

FIG. 3 is a schematic view illustrating how a wooden pallet and a vinyl banner can be recycled and processed to produce a chair with a seat back cover.

FIG. 4 is a flow chart of another exemplary process for recycling waste.

FIG. 5 is a flow chart of a further exemplary process for recycling waste.

FIG. 6 is a flow chart of another exemplary process for recycling waste.

### DETAILED DESCRIPTION OF THE INVENTION

The present invention will be described with reference to the accompanying drawings, in which like reference numerals refer to similar elements. While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

In an effort to increase recycling of waste and turning waste into one or more “new life” products, an entity can implement a recycling process as disclosed herein. An entity's waste can be collected and processed to recycle the waste and produce one or more articles. The articles can be “new life” articles in that the waste has been recycled into a new article, thereby giving the waste material a “new life.” The articles can be provided to the entity for the entity to use or sell. The process can be characterized as a closed-loop process because the waste exits the entity's system, a number of actions are taken, and one or more articles made from the waste are provided back to the entity, thereby reentering the entity's system and “closing” the loop. The process can also include tracking the waste so that the entity can be provided with a certification that the entity's waste was used to produce the article.

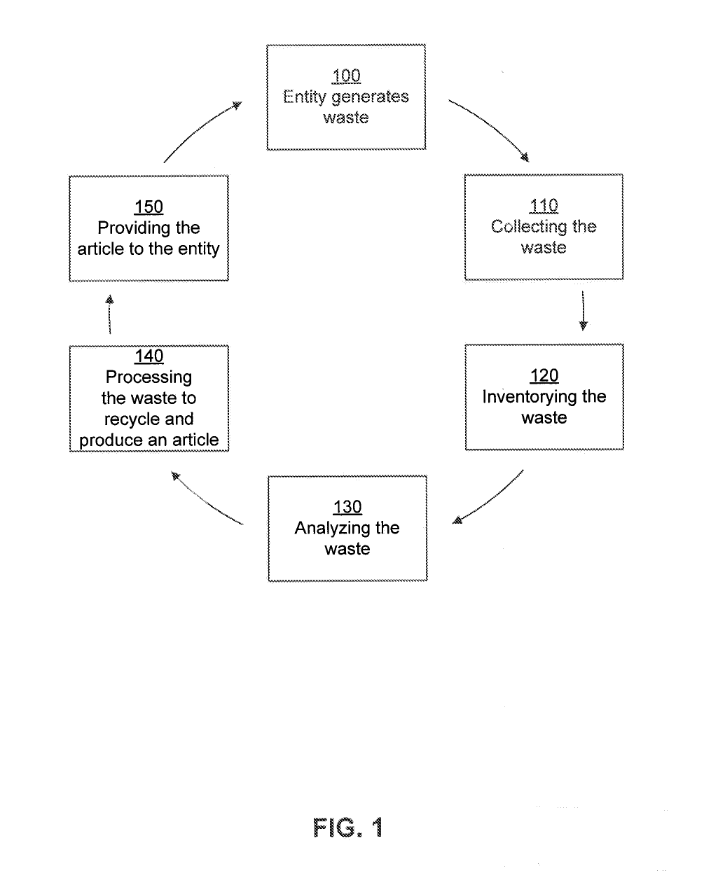

FIG. 1 illustrates a flow chart of an exemplary process for recycling waste. The process can include an entity generating waste (100), collecting waste from the entity (110), inventorying information regarding the waste (120), analyzing the waste (130), processing the waste to recycle the waste and produce an article (140), and providing the article to the entity (150). A more detailed discussion of each of these steps follows.

As shown in element 100, an entity, for example, but not limited to, a company, an institution, or a governmental body, can generate waste. Waste can include recyclable materials such as, but not limited to, wood (for example, crates, pallets, furniture, or displays), plastic (for example, coroplast, shrink-wrap, packaging, or containers), paper (for example, cardboard), glass, metal (for example, aluminum), corrugated material, textiles (for example, shirts, carpets, or other fabrics), rubber, or billboard or signage material.

The waste of an entity can include, but is not limited to, pre-consumer waste, post-consumer waste, and reclaimed waste. Pre-consumer waste, as used herein, means waste created by the entity, but not passed on to the consumer. By way of example, pre-consumer waste can include manufacturing waste, distribution center packaging waste, office waste (for example, textiles, cardboard, corrugated materials, boxes), event waste, or point of sale advertising, banners, signage, or packaging. Post-consumer waste, as used herein, means sources of waste passed on to the consumer. By way of example, post-consumer waste can include the packaging of a product sold to the consumer (such as, for example, a box, container, or bottle) or the actual product sold to the consumer once it has been used (such as, for example, newspaper, magazines, empty cartridges, or used electronics). Post-consumer waste can also include, for example, beverage or food sample containers, dining or serving utensils, clamshell packaging, or other items given to the consumer. Reclaimed waste, as used herein, means items that are no longer needed and can be recycled or reused. By way of example, reclaimed waste can include items that are potentially reusable, but that are no longer needed, for example, pallets, rubber from tires of an entity's delivery truck, or shrink wrap.

In some embodiments, prior to implementing a recycling process, an entity's waste recovery needs can be determined. For example, an entity's sources of waste, including pre-consumer waste, post-consumer waste, and reclaimed waste, can be identified. Once the sources of waste are identified, it can be decided what waste to recycle. It can also be determined what type of “new life” articles can be made from the entity's waste. It can also be determined how and where to recover or collect the waste to be recycled as discussed below.

Step 110 of collecting the waste of an entity can include collecting pre-consumer waste, post-consumer waste, reclaimed waste, or combinations thereof. The waste can be collected from a plurality of locations. Waste can be collected from an entity's facility, such as, for example, a manufacturing or production site, a distribution center, place of business, retail store, or combinations thereof. Also, waste can be collected from a point of sale for the entity's product which is not owned by the entity, for example a grocery store, a convenience store, a retail store, or combinations thereof. In addition, waste can be collected from designated collections sites, such as, for example, a municipal recycling center, athletic venues, entertainment venues, or combinations thereof. In some embodiments, waste can be collected from one or more of the locations discussed above.

In some embodiments, the waste can be placed in a bin or container for collection. If the waste is being collected from a point of sale for the entity's product, which is not owned by the entity, or from a designated collection site, then the bin or container for collection is marked to indicate that it is a receptacle for the entity's waste. This allows consumers to know where to place the entity's waste for recycling. In some embodiments, the waste can be collected on a scheduled basis, on an on-demand basis (for example, when requested), or both. In some embodiments, the collected waste is transported to a warehouse or other facility.

Step 120 of inventorying the waste can include inventorying information regarding the waste. By way of example, the information can include the type of material, the quantity of each type of material, the condition of the material, the size of the material, the location where the waste was collected, or combinations thereof. In some embodiments, the information can be entered into a database, such as a computer database having a memory for storing the information. The database can be connected to a network so that the entity can have real-time access to the database and the information regarding the inventoried waste. In some embodiments, the waste can be inventoried at the collection site. When the waste is inventoried at the collection site, a representative of the entity can be at the collection site to confirm the information that is inventoried. In some embodiments, the collected waste can be transported to a warehouse or other facility and the inventorying occurs at the warehouse or other facility.

Step 130 of analyzing waste can include determining how to recycle the waste. In some embodiments, analyzing can include sorting the waste, identifying how the waste can be recycled into an article, and combinations thereof. In some embodiments, the analyzing can be done by hand, by a computer software program, or a combination thereof.

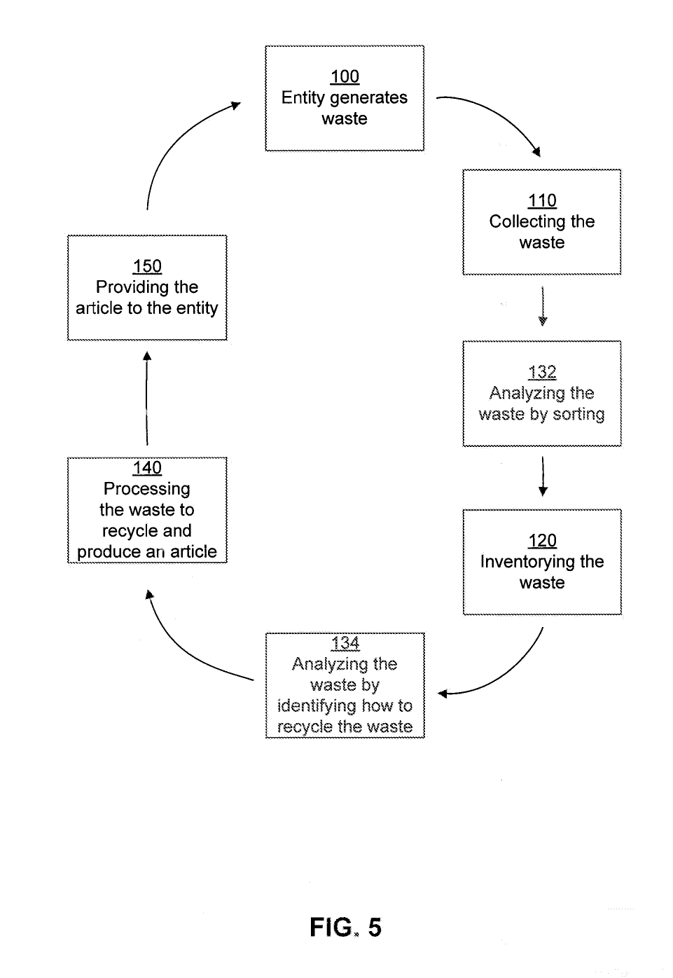

As mentioned above, in some embodiments, analyzing can include sorting the waste. In some embodiments, waste can be sorted based on material such that like waste can be sorted with like material, for example, wood can be sorted and compiled with other wood, paper can be sorted and compiled with other paper, and aluminum can be sorted and compiled with other aluminum. In some embodiments, the waste can be sorted based on the type of processing that is required to recycle the waste, for example, chemical processing, physical processing, or a combination thereof. In some embodiments, the waste can be sorted based on what article the waste will be used to make. In some embodiments, two or more of the above described types of sorting can be used sequentially in any combination of order or simultaneously. By way of example, in some embodiments, the waste can be first sorted by material (e.g., wood, paper, and aluminum) and then subsequently each type of material can sorted by what article the material will be used to make (e.g., aluminum can be sorted into aluminum to be used for making a dog tag or aluminum to be used for making a notebook cover). In other embodiments, the waste can be sorted by material and by what article the material will be used to make simultaneously. For example, waste containing wood and aluminum can be simultaneously sorted into a group of wood for use in making a first type of article, wood for use in making a second type of article, aluminum for use in making a third type of article, aluminum for use in making a fourth type of article. In some embodiments, as discussed below with reference to FIG. 5, step 130 of analyzing the waste can include a step 132 of analyzing the waste by sorting. The sorting of step 132 can include any of the ways of sorting discussed above.

In some embodiments, the analyzing can include identifying how the waste can be recycled into an article, such as a “new life” article. In some embodiments, identifying how the waste can be recycled can include determining if the waste material is suitable for use in making a particle article. By way of example, a wooden pallet can be inspected to determine if the wood is sturdy enough (e.g., not rotted or broken) for use in making a chair.

In some embodiments, identifying how the waste can be recycled into an article can be done by hand, by a computer software program, or a combination thereof. In some embodiments, when the analyzing is performed by a programmable computer system, the computer system is connected to a database containing inventoried information regarding the waste. The programmable computer system can include one or more processors in communication with a memory, wherein the memory includes instructions that when executed by a processor will cause the processor to perform one or more actions. In some embodiments, the instructions can be included in a computer software program. The programmable computer system can include a computer software program that can identify how to recycle the waste based on the information entered into the database to produce one or more articles to provide to the entity. The software program can be programmed with information regarding an “ingredient” list to make one or more types of articles. For example, the software program can be programmed to know that X number of wooden pallets of a certain size is needed to make a chair or to know that Y amount of plastic is needed to make a bag. In some embodiments, the computer software program can be programmed to indicate whether there is enough waste to make one or more articles. If there is not enough waste, the waste can be stored until such time that there is enough waste to make the one or more articles. If there is enough waste to make one or more articles, either from the current collection alone or in combination with stored waste from a previous collection, the waste can be sent to be processed. In some embodiments, as discussed below with reference to FIG. 5, step 130 of analyzing the waste can include a step 134 of analyzing the waste by identifying how the waste can be recycled into an article. The identifying of step 134 can include any of the ways of identifying discussed above.

In some embodiments, analyzing can include determining what the material is and determining its “green strength.” By way of example, when the waste includes plastic advertisement banners or billboard the material can be analyzed to determine what type of plastic it is through methods known in the art. Some plastic has a higher “green strength” than others, meaning that some plastics, such as vinyl, are more easily recyclable and the recycling process has less environmental impact than other plastics, such as polyvinyl chloride (PVC). Based on the “green strength” of the material, a determination can be made as to how to process the material. For example, when analyzing plastic, if it is determined that the plastic is PVC, then the PVC will be used to make an article that involves physical processing rather than chemical processing because chemical processing of PVC can be harmful to the environment.

In some embodiments, the analyzing can be performed at the same time as step 120 of inventorying, prior to step 120 of inventorying, after step 120 of inventorying, or before and after step 120 of inventorying. In some embodiments, for example, the waste can be analyzed to sort the waste, inventoried, and then analyzed to identify how to recycle the waste into an article. In other embodiments, the waste can be inventoried, then analyzed to sort the waste, and then analyzed to identify how to recycle the waste into an article. In yet other embodiments, the waste can be analyzed to sort the waste simultaneously with inventorying the waste. In further embodiments, the waste can be analyzed to sort the waste, analyzed to identify how to recycle the waste into an article, and inventoried simultaneously.

Step 140 of processing the waste can include recycling the waste to produce one or more articles for the entity. In some embodiments, processing the waste to recycle it can include physical processing, chemical processing, or a combination thereof. The processing of the waste can occur in the same location or a different location as the steps of inventorying and/or analyzing.

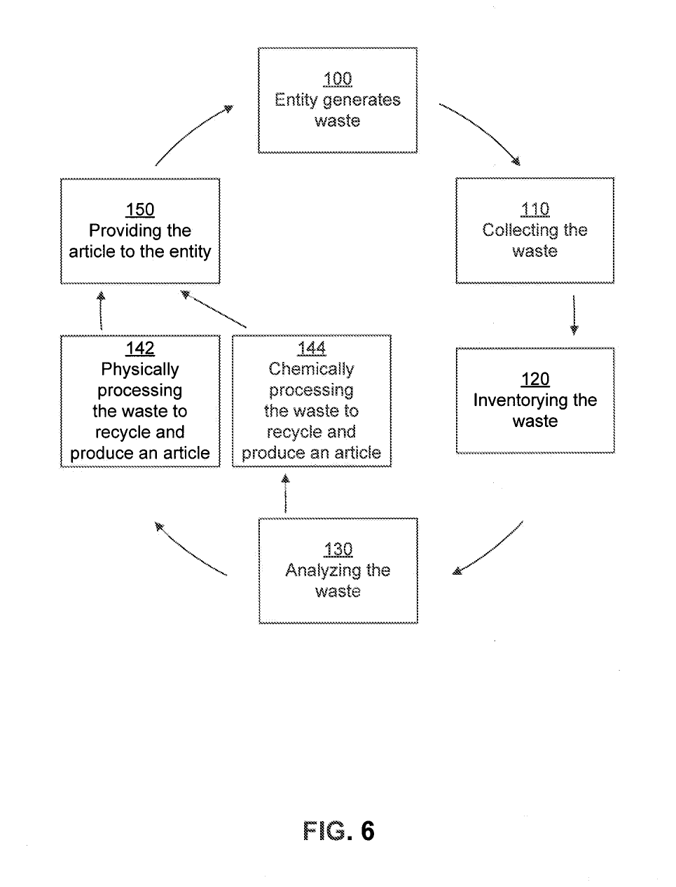

Physical processing, by way of example, can include cutting, sewing, shaping, and/or grinding. Examples of physically processing waste to make an article can include, but is not limited to cutting and sewing vinyl banners to make bags, cutting and reshaping aluminum to make dog tags or key chains, cutting wood from pallets to be used in making a chair, grinding rubber from used tires into playground material, flat pressing rubber, or reshaping labels into pieces of jewelry. In some embodiments, as discussed below with reference to FIG. 6, step 140 of processing the waste can include a step 142 of physically processing the waste. The physical processing of step 142 can include any of the ways of physical processing discussed above.

Chemical processing, by way of example, can include flaking and/or pelletizing the waste through conventional means. In some embodiments, waste that has been chemically processed can be used, for example, to make textiles or plastics. The textiles can be used to manufacture or create a number of different types of articles, including, but not limited to, clothing, bags, and carpets. The plastics can also be used to manufacture or create a number of different types of articles, including, but not limited to bottles, film wrap, packaging, containers, and pallets. In some embodiments, as discussed below with reference to FIG. 6, step 140 of processing the waste can include a step 144 of chemically processing the waste. The chemical processing of step 144 can include any of the ways of chemical processing discussed above.

In some embodiments, processing the waste to recycle the waste and produce an article can transform the waste such that the article is different in form than the waste from which it is produced. For instance, the waste is not processed to form the same type of article as it was before being processed (e.g., a bottle is not made from a bottle). The transformation can be accomplished for example, through the chemical processing and physical processing discussed above. By way of example, the transformation can include turning used PET (polyethylene terephthalate) into uniforms or turning aluminum cans into dog tags. In some embodiments, transforming the waste such that the article is different in form than the waste from which it is produced results in upcycling the waste (i.e., the article made from the waste is of better quality or higher environmental value than the waste).

In some embodiments, a plurality of the same article can be produced from the waste. In some embodiments, a plurality of different types of articles can be produced from the waste. By way of example, when the waste is a glass bottle with a metal cap and a paper label, the glass can be recycled and used to make a first article, the metal cap can be recycled and used to make a second article, and the paper label can be recycled and used to make a third article.

In some embodiments, an article can be produced from a plurality of different types of waste. By way of example, a chair with a seat back cover can be made from wood from a pallet and plastic from an advertisement sign, banner, or billboard such that the wood is used to make the chair and the plastic is used to make the seat back cover for the chair. The different types of waste can be collected from the same location or different locations. For instance, in the example described above with respect to making a chair with a back cover, the wooden pallet and plastic banner can be collected from the same location or different locations.

As mentioned above, prior to implementing a recycling process, an entity's waste recovery needs can be determined and it can be determined what type of articles can be made from the entity's waste. In some embodiments, based on the type of waste to be recovered for the entity; the entity can choose from a selection of available articles that can be made from the entity's waste. In some embodiments, the entity can identify what types of articles would be of use to them and the party running the recycling process can design and create the desired articles for the entity from the entity's waste.

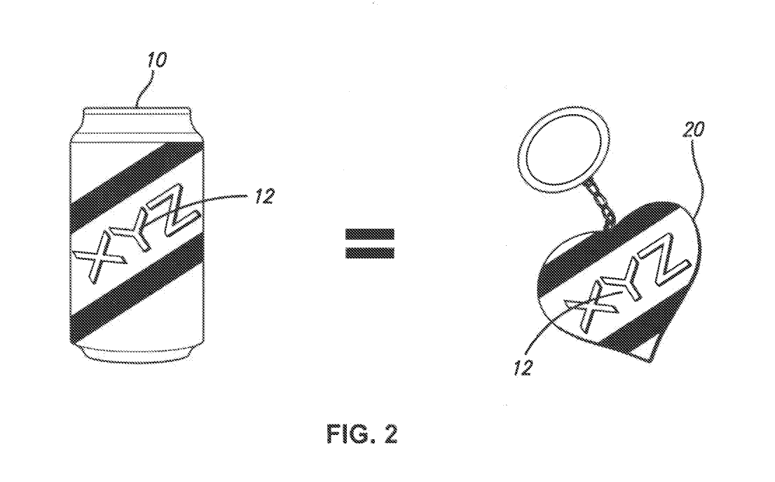

The collected waste can be processed into a variety of articles. By way of example, an aluminum can be processed, such as by flattening the can and cutting the aluminum to size, to produce a key chain, a dog tag, or covers for a notebook. FIG. 2 is a schematic view illustrating that an aluminum can 10 can be recycled and processed into a key chain 20.

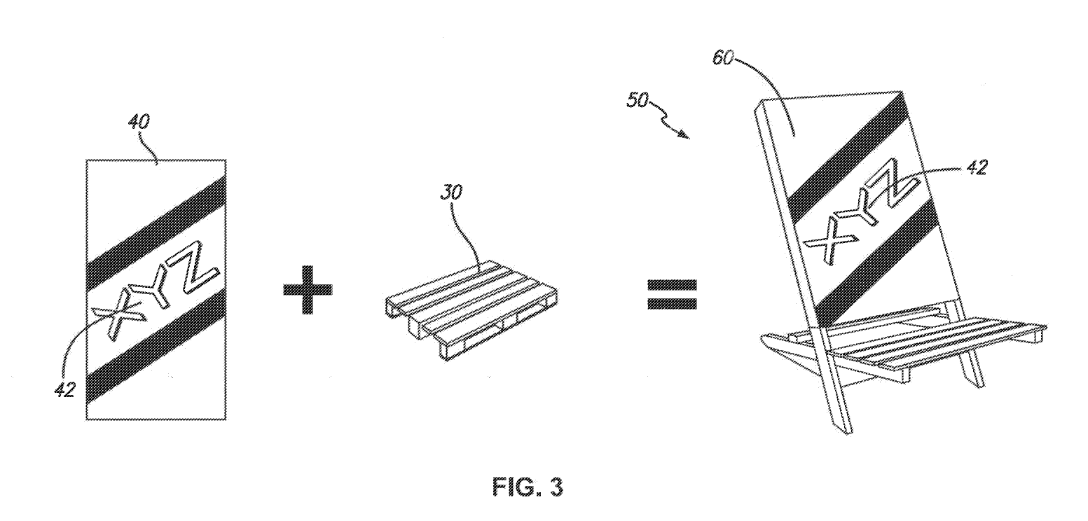

As another example, a wooden pallet and a vinyl banner can be processed to produce a beach chair with a seat back cover. The wooden pallet can be disassembled and the strips of wood can be sawn to size and joined together to form the chair. The vinyl banner can be cut to size and joined to the seat back to form the seat back cover. FIG. 3 is a schematic view illustrating that a wooden pallet 30 and a vinyl banner 40 can be recycled and processed into a beach chair 50 having a seat back cover 60.

Other examples include processing wood, by sawing and joining pieces of wood together to produce a bean bag toss game board (e.g., a slanted wooden platform having one or more openings for tossing a bean bag therethrough), an A-frame sign holder, a menu holder, or a caddy for carrying eating utensils, napkins and/or drinks.

Further examples include processing plastic (e.g., vinyl) signs or banners by a combination of cutting, reshaping, and/or sewing to produce a restaurant bill holder, an apron, an insulated cooler, a tote bag, or a messenger bag.

Additional examples include processing rubber, such as rubber from tires, by grinding the rubber into playground material or pressing the rubber into flat sheets and subsequently cutting the flat sheet to make coasters, key tags, or book covers.

Still further examples include processing corrugated plastic (e.g., coroplast) can be processed, such as by reshaping to produce a lunch box, a tool kit, a writing implement caddy, a notebook, a binder, or a portfolio folder.

In some embodiments, the waste can include a logo, name, symbol, or other identifying feature of the entity or of one of the entity's products. By way of example, an aluminum soda can can have the name of the soda or a vinyl banner or corrugated plastic signage used for advertisement can have the logo or name of the entity. In some embodiments, the article produced from the waste having the identifying feature of the entity can include the entity's identifying feature or a portion thereof, such as for example, any of the products described above as being made from aluminum, a plastic sign or banner, or corrugated plastic. By way of example, in FIG. 2 aluminum soda can 10 can have the name 12 of an entity's soda thereon. The key chain 20 made from aluminum can 10 can have a portion of the name 12 of the entity's soda that was present on aluminum can 10. As another example, in FIG. 3 vinyl banner 40 used to make seat back 60 for chair 50 can include an advertisement or logo 42 identifying an entity. The advertisement or logo 42 can be visible on seat back 60 of chair 50. Thus a waste material having a logo or other identifying feature of the entity (or one of its products) can be processed such that the entire logo or other identifying feature, or a portion thereof, is visible in the article formed from the waste material. In some embodiments, if the waste material does not have a logo or other identifying feature of the entity, the article made from the waste material can be printed, painted, or otherwise placed on the article.

After one or more articles, of the same or different type, are produced from the waste, the process can include step 150 of providing the one or more articles to the entity. Providing the entity with an article produced from its waste closes the loop on the recycling process because the waste which exited the entity's system is returned to the entity's system in the form of the article. In some embodiments, the entity can use the article, for example for promotional purposes. In other embodiments, the entity can sell the article. In alternative embodiments, the one or more articles can be provided to a party other than the entity for sale by the other party. In yet other alternative embodiments, when a plurality of articles are made, some of the articles can be provided to the entity and some of the articles can be provided to a party other than the entity.

In some embodiments, the waste can be tracked through a portion of the recycling process or throughout the entire recycling process. For example, the waste can be tracked for example starting with when the waste is inventoried. As discussed above, in some embodiments, the waste is inventoried at the collection site or at a facility or warehouse to which the collected waste is transported. When the waste is inventoried and entered into a database, the site of collection can also be stored in the database. In some embodiments, after inventorying the waste, the waste can be placed in a container or on a pallet that has a bar code, RFID tag or other tracking means. In some embodiments, this can be part of the sorting process described above. The bar code, RFID tag, or other tracking means can be scanned or read each time the waste is moved, as is known in the art, so that the location of the waste is known at all times and the entity can monitor the location of the waste. In some embodiments, the entity can have access to the tracking information, such as by access to the database, so that the entity knows, for example, when the waste is collected, where the waste is presently located, inventory levels of specific types of waste, the present location of the waste, or when an article is sent to the entity.

In some embodiments, the tracking process is used to maintain records as to how an entity's waste is recycled and what article or articles are made from the waste. As a result, documentation can be created as to the location and movement of the waste during the process, for example, throughout a portion of the process or the entirety of the process, as well as what article or articles were made from the waste. In some embodiments, when providing the entity with the article made from its waste, the entity is also provided with a certification that its waste was used to make the article. Thus, the entity can have documentation as proof that its waste has been recycled. In some embodiments, the article is also provided with a tag or pamphlet that describes how the article was made from recycled waste and provides educational information for the users of the article regarding recycling.

The process shown in the flow chart illustrated in FIG. 1 is merely exemplary and one or more steps shown in the FIG. 1 could not be included in a recycling process. Similarly, one or more additional steps could also be included in the process shown in the flow chart of FIG. 1.

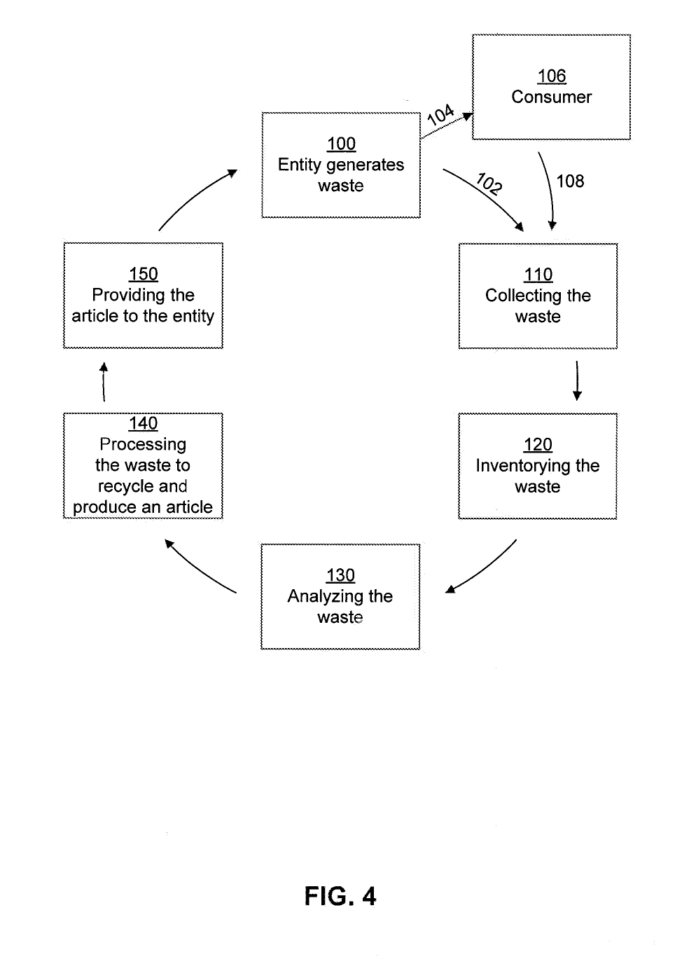

FIG. 4 is an exemplary flow chart of the recycling process expanding upon the flow chart illustrated in FIG. 1 to illustrate an entity's waste can be collected from the entity or from the entity's consumers. The flow chart includes several steps previously outlined in FIG. 1.

Element 100 in FIG. 4 can correspond to element 100 in FIG. 1. As shown in element 100 an entity can generate waste and the waste can include pre-consumer waste, post-consumer waste, and reclaimed waste. As shown by arrow 102, some of the entity's waste, for example pre-consumer waste and/or reclaimed waste, can be collected directly from the entity at one or more of the entity's facilities. The entity's facilities can include, for example, a manufacturing or production site, a distribution center, place of business, retail store, or combinations thereof.

As shown by arrow 104, an entity can send products to the entity's consumer 106, which ultimately become post-consumer waste. In some embodiments, when the entity sends products to its consumer 106 it can also send the associated packaging, such as pallets or shrink wrap, which in turn can become reclaimed waste. Thus, arrow 104 represents materials the entity sends to consumer 106, which ultimately become waste either in the form of post-consumer waste and/or reclaimed waste. As shown by arrow 108 such post-consumer waste and/or reclaimed waste can be collected from the consumer, such as from a designated collection site at the point-of-sale or elsewhere in the community.

Step 110 of collecting the waste, step 120 of inventorying the waste, step 130 of analyzing the waste, step 140 of processing the waste to recycle and produce an article, and step 150 of providing the article to the entity illustrated in FIG. 4 can correspond to steps 110, 120, 130, 140, and 150 of FIG. 1.

FIG. 5 is an exemplary flow chart of the recycling process expanding upon the flow chart illustrate in FIG. 1 to illustrate analyzing the waste can occur before and after inventorying the waste. The flow chart includes several steps previously outlined in FIG. 1.

Element 100 (an entity generating waste) in FIG. 5 can correspond to element 100 in FIG. 1. Step 110 of collecting the waste, step 120 of inventorying the waste, step 140 of processing the waste to recycle and produce an article, and step 150 of providing the article to the entity illustrated in FIG. 5 can correspond to steps 110, 120, 140, and 150 of FIG. 1. Step 130 of analyzing the waste illustrated in FIG. 1, is shown as being divided into step 132 of analyzing the waste by sorting and step 134 of analyzing the waste by identifying how to recycle the waste into an article in the process illustrated in FIG. 5.

As shown in FIG. 5, the process can include step 132 of analyzing the waste by sorting after step 110 of collecting the waste and prior to step 120 of inventorying the waste. As described above, step 132 of analyzing the waste by sorting can correspond to any of the ways of sorting described above with respect to step 130 of analyzing the waste in FIG. 1. In some embodiments, waste can be sorted based on material such that like waste can be sorted with like material, based on the type of processing that is required to recycle the waste, based on what article the waste will be used to make, or combinations thereof.

As shown in FIG. 5, the process can include step 134 of analyzing the waste by identifying how to recycle the waste into an article after step 120 of inventorying the waste. As described above, step 134 of analyzing the waste by identifying how to recycle the waste into an article can correspond to any of the ways of identifying described above with respect to step 130 of analyzing the waste in FIG. 1. In sortie embodiments, identifying how the waste can be recycled can include determining if the waste material is suitable for use in making a particle article. In some embodiments, identifying how the waste can be recycled into an article can be done by hand, by a computer software program, or a combination thereof.

FIG. 6 is an exemplary flow chart of the recycling process expanding upon the flow chart illustrate in FIG. 1 to illustrate step 140 of processing the waste to recycle and produce an article from FIG. 1 can include a step 142 of physically processing the waste to recycle and produce an article and/or a step 144 of chemically processing the waste to recycle and produce an article. The flow chart includes several steps previously outlined in FIG. 1.

Element 100 (an entity generating waste) in FIG. 6 can correspond to element 100 in FIG. 1. Step 110 of collecting the waste, step 120 of inventorying the waste, step 130 of analyzing the waste, and step 150 of providing the article to the entity illustrated in FIG. 6 can correspond to steps 110, 120, 130, and 150 of FIG. 1. Step 140 of processing the waste to recycle and produce an article illustrated in FIG. 1, is shown as being divided into step 142 of physically processing the waste to recycle and produce an article and/or a step 144 of chemically processing the waste to recycle and produce an article in the process illustrated in FIG. 6.

As shown in FIG. 6, the process can include step 142 of physically processing the waste. As described above, step 142 of physically processing the waste can correspond to any of the ways of physical processing described above with respect to step 140 of processing the waste in FIG. 1. For example, physical processing can include cutting, sewing, and/or shaping.

As shown in FIG. 6, the process can include step 144 of chemically processing the waste. As described above, step 144 of chemically processing the waste can correspond to any of the ways of chemical processing described above with respect to step 140 of processing the waste in FIG. 1. For example, chemical processing can include flaking and/or pelletizing the waste through conventional means.

The processes shown in the flow charts illustrated in FIGS. 4-6 are merely exemplary and one or more steps shown in each of FIGS. 4-6 could not be included in a recycling process. Similarly, one or more additional steps could also be included in the process shown in the flow charts of FIGS. 4-6. For example the steps of FIG. 4 not present in FIGS. 5 and 6 could be included in the flow charts illustrated in FIGS. 5 and 6, the steps of FIG. 5 not present in FIGS. 4 and 6 could be included in the flow charts illustrated in FIGS. 4 and 6, or the steps of FIG. 6 not present in FIGS. 4 and 5 could be included in the flow charts illustrated in FIGS. 4 and 5.

In some embodiments, a party organizing, managing, and/or overseeing the recycling process described herein can do so for a plurality of entities (e.g., two, three, four, or more entities). Each entity's waste can be processed and recycled according to any combination of the steps of the processes discussed above and illustrated in FIGS. 1 and 4-6. In some embodiments, the waste for each entity can be collected, inventoried, analyzed, and/or processed at the same locations or facilities as waste of other entities. It is important to keep each entity's waste segregated in order to provide each entity with one or more articles made from its own waste and not from waste of the other entities. Segregating the waste of each of entity from the other in order to prevent mixing of waste from the different entities can facilitate tracking of each entity's waste and providing a certification to each entity that the one or more articles provided to the entity was made from its own waste and not the waste of the other entity. In some embodiments, the one or more articles provided to each entity do not contain waste from the other entity. In other embodiments, the one or more articles provided to each entity can contain waste from the other entity.

In some embodiments, segregation of the waste of each entity from the other can be accomplished by collecting the waste of each entity in different vehicles. In other embodiments, when the waste of both entity A and entity B are collected in the same vehicle, segregation of the waste of each entity from the other can be accomplished by maintaining the waste of each entity in separate sections of the vehicle or in separately marked bins or containers. The segregation of each entity's waste from the other can be maintained throughout the process.

In some embodiments, if an entity does not want an article made from a portion of its waste, or all of its waste, the waste can be used to make a “generic” new life article, which can be sold to someone other than the entity. In some embodiments, if multiple entities do not want an article made from a portion of its waste, or all of its waste, the waste from the multiple entities can be combined to make “generic” new life articles.

In some embodiments, two or more entities can have a portion of their waste, or all of their waste, combined to make new life articles for use by both entities. The combination of waste can occur at any point in the process prior to step 140 of processing the waste to recycle the waste and produce an article. By way of example, entity A and entity B can have all of their vinyl banners combined and processed together to make articles, such as bags. Each entity can be provided with certification and documentation that some of its waste material is included in the article. In some embodiments, the percentage of the entity's waste used to make the article can be specified, for example 10%, 25%, or 50%. For example, a bag made from a combination of vinyl banners from entity A and entity B can be sent to entity A with a certification of what percent of the bag was made from entity A's vinyl banners or can be sent to entity B with a certification of what percent of the bag was made from entity B's vinyl banners.

The recycling processes described above, provides an entity with a means for implementing a waste recycling process to provide “new life” articles. The process can be characterized as a closed-loop process because the waste exits the entity's system, a number of actions are taken, and one or more articles made from the waste are provided back to the entity, thereby reentering the entity's system and “closing” the loop. The process can also include tracking the waste so that the entity can be provided with certification that the entity's waste was used to produce the article. Thus, an entity is able to document its “greenness” through the documentation certifying that its waste has been recycled to produce “new life” products.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A process for recycling waste comprising:
collecting waste of an entity, wherein the waste includes an identifying feature of the entity;
inventorying information regarding, the waste;
analyzing the waste in order to determine how to recycle the waste;
producing an article from the analyzed waste, thereby recycling the waste, wherein the article includes a portion of the identifying feature such that there is a visible indication that the article was made from the waste of the entity;
providing the article to the entity;
tracking the waste during the process; and
providing the entity with a certification that the entity's waste was used to produce the article.

2. The process of claim 1, wherein the waste is selected from the group consisting of pre-consumer waste, post-consumer waste, reclaimed waste, and combinations thereof.

3. The process of claim 1, wherein inventorying and analyzing occur simultaneously.

4. The process of claim 1, wherein analyzing the waste comprises sorting the waste.

5. The process of claim 1, wherein analyzing the waste comprises identifying how the waste can be recycled.

6. The process of claim 1, wherein inventorying comprises entering the information into a database.

7. The process of claim 6, wherein:
analyzing the waste comprises identifying how the waste can be recycled with a programmable computer system, wherein the programmable computer system includes:
a memory including a computer software program having instructions for identifying how to recycle the waste; and
a processor in communication with the memory for executing instructions of the computer software program; and
producing the article comprises processing the waste in a manner identified by the computer software program.

8. The process of claim 1, wherein producing the article comprises chemical processing of the analyzed waste.

9. The process of claim 1, wherein producing the article comprises physical processing of the analyzed waste.

10. The process of claim 1, further comprising collecting waste from a plurality of entities in a manner such that the waste of each of the plurality of entities is segregated in order to prevent mixing of waste from different entities, keeping the waste of each of the plurality of entities segregated throughout the process, and tracking the waste of each of the plurality of entities during the process.

11. The process of claim 1, wherein the article is different in form than the waste from which it is produced.

12. The process of claim 1, wherein a plurality of different types of articles is produced from the waste.

13. The process of claim 1, wherein a plurality of the same article is produced from the waste.

14. A process for recycling waste comprising:
collecting waste from a plurality of entities, wherein the waste from each of the plurality of entities is segregated in order to prevent mixing of waste from different entities and wherein the waste of each entity includes an identifying feature of the entity;
keeping the waste of each of the plurality of entities segregated throughout the process;
analyzing the waste of each of the plurality of entities in order to determine how to recycle the waste;
producing an article from the analyzed waste of each of the plurality of entities, thereby recycling the waste; and
providing each of the plurality of entities the article made from its waste, wherein the article does not contain waste from a remainder of the plurality of entities and wherein the article includes a portion of the identifying feature such that there is a visible indication that the article was made from the waste of the entity.

15. The process of claim 14, wherein analyzing the waste comprises sorting the waste.

16. The process of claim 14, wherein producing the article comprises chemical processing of the analyzed waste.

17. The process of claim 14, wherein producing the article comprises physical processing of the analyzed waste.

18. The process of claim 14, wherein the waste of one of the plurality of entities is processed to produce a plurality of the same article.

19. The process of claim 14, wherein the waste of one of the plurality of entities is processed to produce a plurality of different types of articles.

20. The process of claim 14, wherein the article of one of the plurality of entities is different from the article of another of the plurality of entities.

21. An article produced by a process for recycling waste comprising, the process comprising:
collecting waste of an entity, wherein the waste includes an identifying feature of the entity;
inventorying information regarding the waste;
analyzing the waste in order to determine how to recycle the waste;
producing an article from the analyzed waste, thereby recycling the waste wherein the article includes a portion of the identifying feature such that there is a visible indication that the article was made from the waste of the entity;
providing the article to the entity;
tracking the waste during the process; and
providing the entity with a certification that the entity's waste was used to produce the article.

22. An article produced by a process for recycling waste, the process comprising:
collecting waste from a plurality of entities, wherein the waste from each of the plurality of entities is segregated in order to prevent mixing of waste from different entities and wherein the waste of each entity includes an identifying feature of the entity;
keeping the waste of each of the plurality of entities segregated throughout the process;
analyzing the waste of each of the plurality of entities in order to determine how to recycle the waste;
producing an article from the analyzed waste of each of the plurality of entities, thereby recycling the waste; and
providing each of the plurality of entities the article made from its waste, wherein the article does not contain waste from a remainder of the plurality of entities and wherein the article a portion of the identifying feature such that there is a visible indication that the article was made from the waste of the entity.

23. The process of claim 1, wherein the waste includes a plurality of different types of material.

24. (canceled)

25. The process of claim 1, wherein the collecting comprises collecting the waste of the entity from a point of sale of a product of the entity, wherein the entity does not own the point of sale.

26. The process of claim 14, wherein the waste of each of the plurality of entities includes a plurality of different types of material.

27. (canceled)

28. The process of claim 14, wherein the collecting comprises collecting the waste of each entity from a point of sale of a product of the entity, wherein the entity does not own the point of sale.

29. The process of claim 14, wherein:
analyzing the waste comprises identifying how the waste can be recycled with a programmable computer system, wherein the programmable computer system includes:
a memory including a computer software program having instructions for identifying how to recycle the waste; and
a processor in communication with the memory for executing instructions of the computer software program; and
producing the article comprises processing the waste in a manner identified by the computer software program.
